(19) United States
(12) Patent Application Publication
(10) Pub. No.: US 2026/0138370 A1
(43) Pub. Date: May 21, 2026

(54) LIQUID EJECTION APPARATUS

(71) Applicant: SEIKO EPSON CORPORATION, TOKYO (JP)

(72) Inventor: Moe ONO, SHIOJIRI-SHI (JP)

(21) Appl. No.: 19/392,213

(22) Filed: Nov. 18, 2025

(30) Foreign Application Priority Data
Nov. 18, 2024 (JP) 2024-200770
Nov. 18, 2024 (JP) 2024-200771

(51) Int. Cl. B41J 2/17; B41J 2/165

(52) U.S. Cl. CPC B41J 2/1721; B41J 2/16511; B41J 2002/16594

(57) ABSTRACT

A liquid ejection apparatus includes a head unit having a nozzle surface configured to eject a liquid toward a medium, a plurality of caps, a receiving member configured to receive the liquid discharged from the plurality of caps, and a discharge flow path configured to connect the receiving member and a waste liquid container to each other, wherein the cap includes a lip portion, and an outflow portion that is located at an opposite side to the head unit, and the receiving member includes a plurality of inflow portions coupled respectively to a plurality of outflow portions each identical to the outflow portion, a discharge portion to which the discharge flow path is coupled, and a merging flow path configured to connect the plurality of inflow portions and the discharge portion to each other.

The present application is based on, and claims priority from JP Application Serial Number 2024-200770, filed November 18, 2024, and JP Application Serial Number 2024-200771, filed November 18, 2024, the disclosures of which are hereby incorporated by reference herein in its entirety.

### BACKGROUND

### 1. Technical Field

The present disclosure relates to a liquid ejection apparatus such as a printer.

### 2. Related Art

As disclosed in, for example, JP-A-2021-8061, there is a liquid ejection apparatus that performs printing by ejecting a liquid from a liquid ejection head. The liquid ejecting apparatus includes a plurality of caps, a plurality of branch flow paths, a merging flow path, and a pressure reduction unit. The liquid ejection head includes a plurality of nozzles. The plurality of caps each covers the plurality of nozzles. The branch flow path connects the cap corresponding thereto and the merging flow path to each other. The pressure reduction unit discharges the liquid from each nozzle by reducing the pressure in the plurality of caps via the merging flow path and the plurality of branch flow paths.

JP-A-2021-8061 is an example of the related art.

The branch flow paths in JP-A-2021-8061 are each formed of a tube. However, when the tubes are respectively coupled to the caps, a space for routing the plurality of tubes is required. Therefore, the apparatus grows in size.

### SUMMARY

A liquid ejection apparatus which solves the problems described above includes a head unit having a nozzle surface provided with a plurality of nozzles configured to eject a liquid toward a medium, a plurality of caps configured to receive the liquid discharged from the head unit, a receiving member configured to receive the liquid discharged from the plurality of caps, and a discharge flow path configured to connect the receiving member and a waste liquid container to each other, wherein the plurality of caps each includes a lip portion configured to come into contact with the nozzle surface, and an outflow portion that is located at an opposite side to the head unit with respect to the lip portion to be in contact with the nozzle surface and is configured to cause the liquid received to flow out, and the receiving member includes a plurality of inflow portions coupled respectively to a plurality of outflow portions each identical to the outflow portion, a discharge portion to which the discharge flow path is coupled, and a merging flow path configured to connect the plurality of inflow portions and the discharge portion to each other.

### BRIEF DESCRIPTION OF THE DRAWINGS

FIG. 1 is a schematic diagram of a liquid ejection apparatus.

FIG. 2 is a schematic plan view of a maintenance unit and a positioning unit.

FIG. 3 is a cross-sectional view along the arrowed line 3-3 in FIG. 2.

FIG. 4 is a cross-sectional view along the arrowed line 4-4 in FIG. 2.

FIG. 5 is a schematic cross-sectional view of the maintenance unit in a capping state.

### DESCRIPTION OF EMBODIMENTS

### Embodiment

An embodiment of a liquid ejection apparatus will hereinafter be described with reference to the drawings. The liquid ejection apparatus is an inkjet type printer that ejects ink as an example of a liquid onto a medium such as paper, fabric, a vinyl sheet, a plastic component, or a metal component to perform printing.

In the drawings, a direction of gravity is represented by a Z axis, and directions along a horizontal plane are represented by an X axis and a Y axis assuming that the liquid ejection apparatus 11 is placed on the horizontal plane. The X axis, the Y axis, and the Z axis are perpendicular to each other.

### Liquid Ejection Apparatus

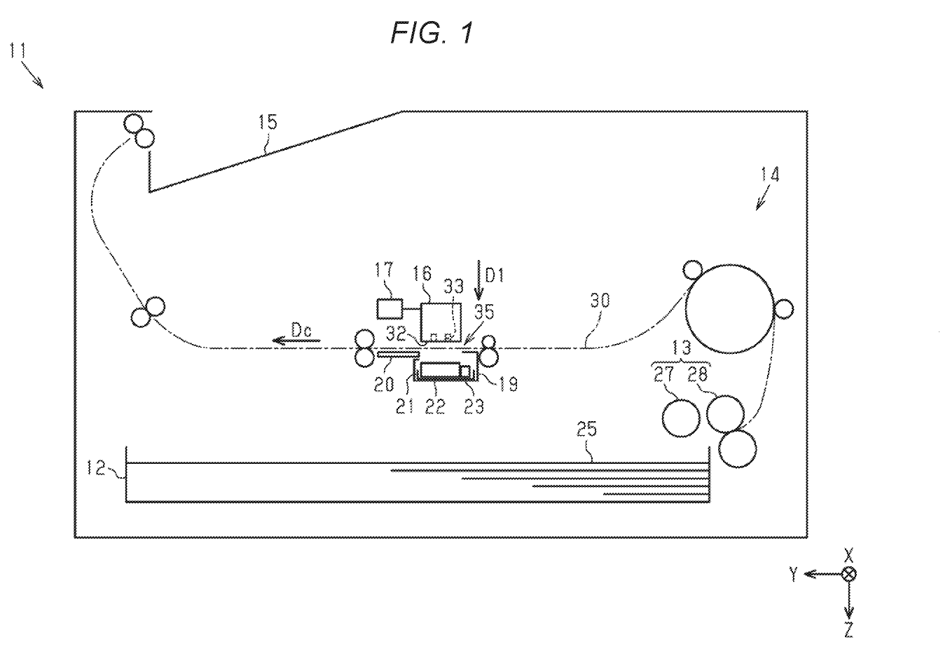

As illustrated in FIG. 1, the liquid ejection apparatus 11 may include a cassette 12, a feed unit 13, a conveyance unit 14, and a stacker 15. The liquid ejection apparatus 11 may include a head unit 16 and a moving mechanism 17. The liquid ejection apparatus 11 may include an opposed portion 19, a cover 20, a tray 21, a maintenance unit 22, and a positioning unit 23.

The cassette 12 can house a medium 25. When the medium 25 is a paper sheet, the cassette 12 may house a bundle of media 25 to be printed.

The feed unit 13 feeds the medium 25 housed in the cassette 12. The term feed means to feed, one by one, the media 25 stacked in the cassette 12. The feed unit 13 may include a feed roller 27 and a separation unit 28. The feed roller 27 rotates in a state of having contact with the medium 25 to thereby feed the medium 25 to the separation unit 28. When the plurality of media 25 is fed in a stacked state, the separation unit 28 separates the plurality of media 25.

The conveyance unit 14 conveys the medium 25 in a conveyance direction Dc along a conveyance path 30 indicated by a dashed-dotted line in FIG. 1. The conveyance unit 14 may be configured including a plurality of rollers. The conveyance unit 14 may convey the medium 25 by sandwiching the medium 25 with a pair of rollers and rotating the rollers. The conveyance unit 14 sends, to the stacker 15, the medium 25 fed from the cassette 12 by the feed unit 13.

The stacker 15 receives the medium 25 conveyed by the conveyance unit 14. The stacker 15 can stack the plurality of media 25 having been recorded.

The head unit 16 has a nozzle surface 32. A plurality of nozzles 33 is provided to the nozzle surface 32. The plurality of nozzles 33 ejects the liquid toward the medium 25. The head unit 16 performs printing on the medium 25 thus conveyed by ejecting the liquid from each of the nozzles 33. The head unit 16 in the present embodiment is configured as a line type provided to be elongated in a width direction of the medium 25.

The moving mechanism 17 moves the head unit 16 and the maintenance unit 22 in a first direction D1 relative to each other. The moving mechanism 17 may reciprocate, for example, the head unit 16 in the first direction D1. The first direction D1 may be, for example, a direction parallel to the Z axis. The first direction D1 may be, for example, a direction perpendicular to the nozzle surface 32.

The opposed portion 19 is disposed so as to face the head unit 16. The opposed portion 19 may be disposed below the nozzle surface 32. The opposed portion 19 may be disposed at an opposite side to the head unit 16 across the conveyance path 30. The opposed portion 19 may house the tray 21, the maintenance unit 22, and the positioning unit 23. An opening 35 is provided to the opposed portion 19. The opening 35 is located between the head unit 16 and the maintenance unit 22. The opening 35 exposes the maintenance unit 22 to the head unit 16.

The cover 20 is movable between an open position shown in FIG. 1 and a closed position (not shown). The open position is a position where the opening 35 is opened. The closed position is a position where the opening 35 is closed. The cover 20 may slide along the conveyance path 30. For example, when the head unit 16 performs printing on the medium 25 conveyed, the cover 20 may be located at the closed position to support the medium 25. For example, when maintenance of the head unit 16 is performed, the cover 20 may move to the open position.

The tray 21 can receive the liquid leaking from, for example, the maintenance unit 22. The tray 21 may support the maintenance unit 22 and the positioning unit 23. In other words, the maintenance unit 22 and the positioning unit 23 may be disposed in the tray 21.

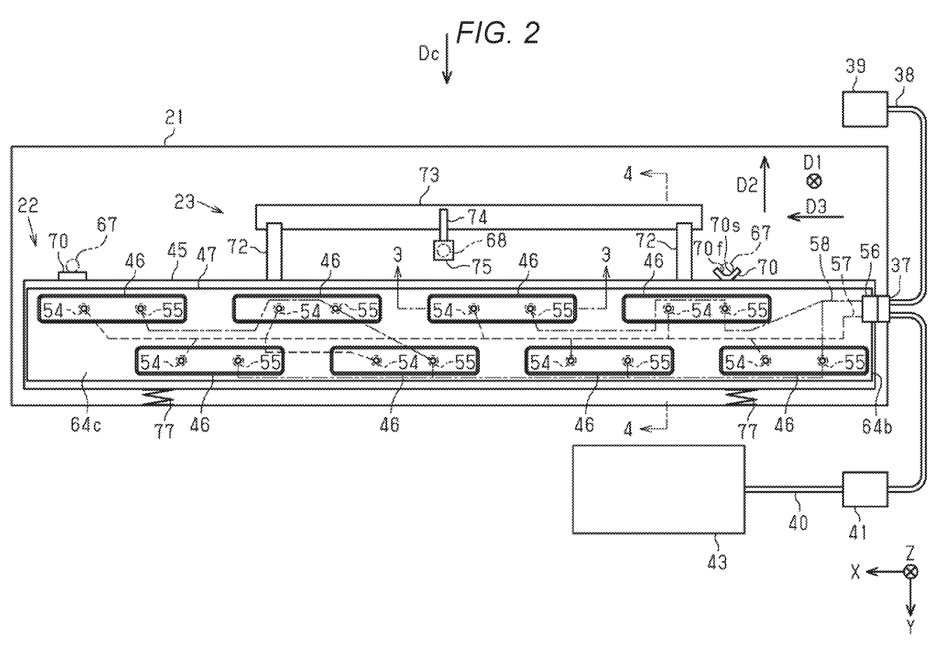

As illustrated in FIG. 2, the liquid ejection apparatus 11 may include a connector 37, an open flow path 38, an open valve 39, a discharge flow path 40, and a suction pump 41.

The connector 37 is detachably attached to the maintenance unit 22. The connector 37 couples the open flow path 38 and the discharge flow path 40 to the maintenance unit 22.

The open flow path 38 may couple the connector 37 and the open valve 39 to each other. The open valve 39 can open an inside of the open flow path 38 to the atmosphere.

The discharge flow path 40 may couple the connector 37 and a waste liquid container 43 to each other. The waste liquid container 43 may store, as a waste liquid, the liquid discharged from the head unit 16 by the maintenance unit 22. The waste liquid container 43 may be a tank provided to the liquid ejection apparatus 11. The waste liquid container 43 may be a replaceable cartridge.

The suction pump 41 may be provided to the discharge flow path 40. The suction pump 41 sends a fluid in the discharge flow path 40 to the waste liquid container 43 by setting the discharge flow path 40 between the suction pump 41 and the connector 37 to negative pressure.

### Maintenance Unit

As shown in FIG. 2, the maintenance unit 22 is configured including a support portion 45, a plurality of caps 46, and a receiving member 47.

The support portion 45 supports the plurality of caps 46 and the receiving member 47.

The plurality of caps 46 receives the liquid discharged from the head unit 16. The plurality of caps 46 may cause the liquid to be discharged from the nozzles 33. The plurality of caps 46 is arranged in accordance with the positions of the plurality of nozzles 33 provided to the head unit 16. The plurality of caps 46 may be disposed at respective positions shifted from each other in a second direction D2 and a third direction D3. In the maintenance unit 22 in the present embodiment, two rows of four caps 46 arranged in the third direction D3 are disposed at respective positions shifted in the second direction D2 and the third direction D3. The second direction D2 may be, for example, a direction parallel to the Y axis. The third direction D3 may be a direction parallel to the X axis. The second direction D2 and the third direction D3 may be parallel to the nozzle surface 32.

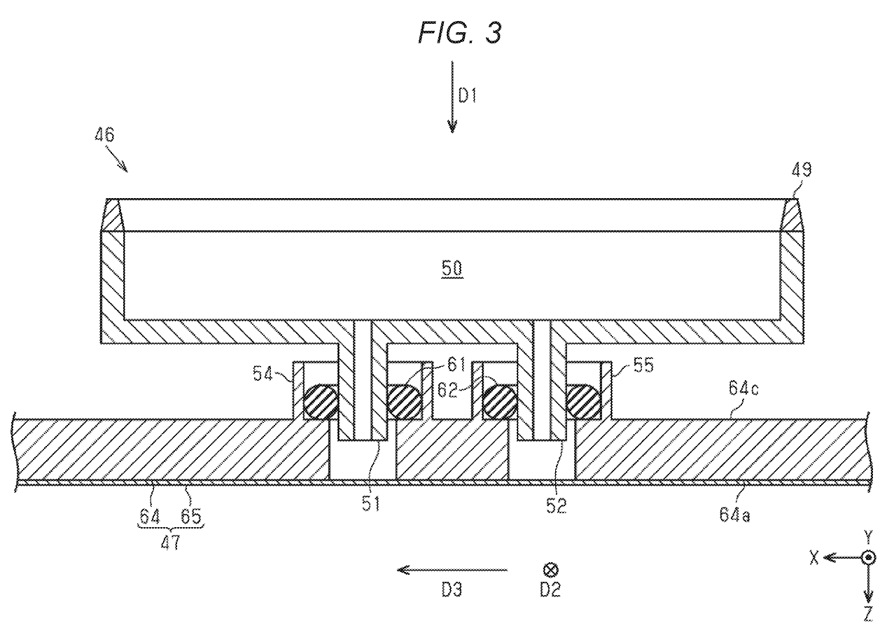

As illustrated in FIG. 3, the caps 46 may each include a lip portion 49, a pressure reduction chamber 50, an outflow portion 51, and an intake portion 52.

The lip portion 49 may constitute an upper end of the cap 46. The lip portion 49 can make contact with the nozzle surface 32. When the lip portion 49 is provided with elasticity, adhesion between the cap 46 and the nozzle surface 32 can be improved.

When the lip portion 49 comes into contact with the nozzle surface 32, the pressure reduction chamber 50 becomes a closed space surrounding the plurality of nozzles 33. An action of the cap 46 forming the closed space is also referred to as capping. When an inside of the pressure reduction chamber 50 is depressurized in the capping state, the liquid is discharged from the plurality of nozzles 33. The pressure reduction chamber 50 receives the liquid thus discharged.

The outflow portion 51 and the intake portion 52 communicate with the pressure reduction chamber 50. The outflow portion 51 and the intake portion 52 may extend in the same direction from the pressure reduction chamber 50. The outflow portion 51 and the intake portion 52 may extend downward from the pressure reduction chamber 50. The outflow portion 51 and the intake portion 52 may extend from the pressure reduction chamber 50 toward the receiving member 47.

The outflow portion 51 and the intake portion 52 are located at an opposite side to the head unit 16 with respect to the lip portion 49 to be in contact with the nozzle surface 32. The outflow portion 51 allows the liquid received by the cap 46 to flow out. The intake portion 52 takes air into the pressure reduction chamber 50 to increase the pressure in the pressure reduction chamber 50 thus depressurized. The outflow portion 51 and the intake portion 52 may be inserted into the receiving member 47.

As shown in FIG. 2, the plurality of caps 46 is attached to the receiving member 47. The receiving member 47 receives the liquid discharged from the plurality of caps 46. The receiving member 47 may feed air into the plurality of caps 46.

The receiving member 47 may include a plurality of inflow portions 54, a plurality of delivery portions 55, and a discharge portion 56. One inflow portion 54 and one delivery portion 55 correspond to one cap 46. The receiving member 47 may include a merging flow path 57 indicated by a broken line in FIG. 2 and an air flow path 58 indicated by a dashed-dotted line in FIG. 2.

The merging flow path 57 couples the plurality of inflow portions 54 and the discharge portion 56 to each other. The merging flow path 57 may be a flow path in which a plurality of flow paths respectively connected to the plurality of inflow portions 54 merges with each other. The air flow path 58 connects the plurality of delivery portions 55 and the discharge portion 56 to each other. The merging flow path 57 and the air flow path 58 are independent of each other, and may three-dimensionally intersect with each other.

The connector 37 is connectable to the discharge portion 56. That is, the discharge flow path 40 may be coupled to the discharge portion 56. The discharge portion 56 and the connector 37 couple the merging flow path 57 and the discharge flow path 40 to each other. The discharge flow path 40 connects the receiving member 47 and the waste liquid container 43 to each other. The discharge flow path 40 is detachably attached to the receiving member 47.

Similarly, the open flow path 38 is coupled to the discharge portion 56. The discharge portion 56 and the connector 37 couple the air flow path 58 and the open flow path 38 to each other. The open flow path 38 connects the receiving member 47 and the open valve 39 to each other. The open flow path 38 is detachably attached to the receiving member 47.

As shown in FIG. 3, the inflow portion 54 and the outflow portion 51 may be coupled to each other by inserting one into the other. The plurality of inflow portions 54 is coupled respectively to the plurality of outflow portions 51.

The delivery portion 55 and the intake portion 52 may be coupled to each other by inserting one into the other. The plurality of delivery portions 55 is coupled respectively to the plurality of intake portions 52.

The maintenance unit 22 may include a plurality of first seal members 61 and a plurality of second seal members 62 as an example of a seal member. A gap between the outflow portion 51 and the inflow portion 54 is caulked with the first seal member 61. A gap between the intake portion 52 and the delivery portion 55 is caulked with the second seal member 62.

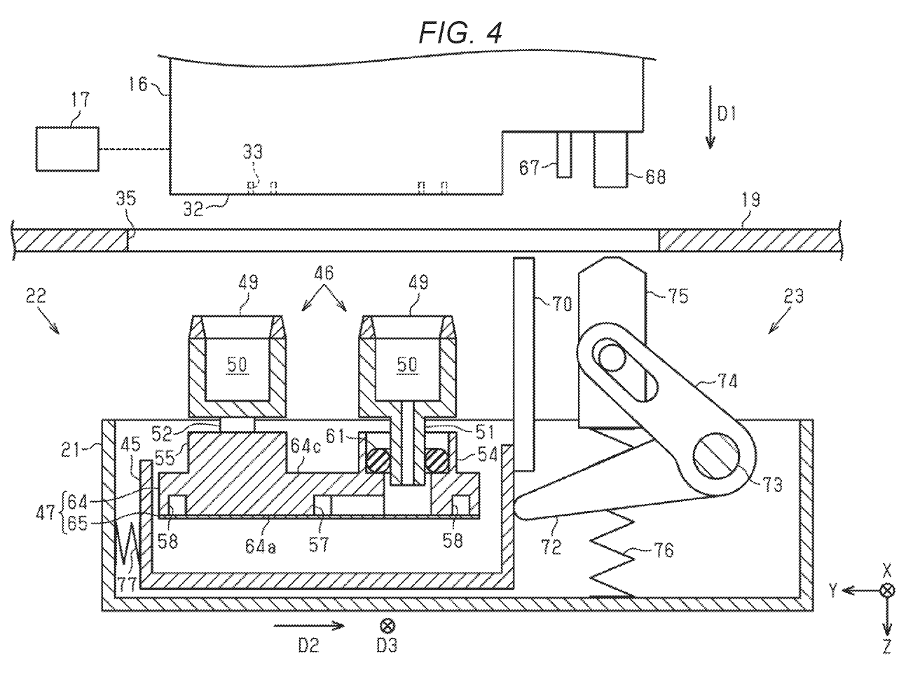

As shown in FIG. 4, the receiving member 47 may include a base member 64 and a covering member 65.

The base member 64 may have a plate shape. The base member 64 may have a first surface 64a to a third surface 64c. The first surface 64a and the third surface 64c are shown in FIG. 4. The second surface 64b is shown in FIG. 2.

The first surface 64a and the third surface 64c may be surfaces perpendicular to the first direction D1. The first surface 64a may be a surface at an opposite side to the caps 46. The first surface 64a may be a lower surface. The third surface 64c may be a surface facing the caps 46. The third surface 64c may be an upper surface. The inflow portion 54 and the delivery portion 55 may be disposed at the third surface 64c.

The second surface 64b shown in FIG. 2 may be a side surface. The second surface 64b may be a surface perpendicular to the third direction D3. The second surface 64b crosses the first surface 64a and the third surface 64c. The discharge portion 56 may be disposed at the second surface 64b.

As shown in FIG. 4, the base member 64 and the covering member 65 may form the merging flow path 57 and the air flow path 58. Specifically, in the base member 64, for example, grooves may be formed at the first surface 64a. The covering member 65 is bonded to the base member 64 to cover the grooves. The merging flow path 57 may be formed between the covering member 65 and the groove. The air flow path 58 may be formed between the covering member 65 and the groove. The term bond means that two things adhere to each other and are not separated from each other, and includes welding, fusion, and adhesion. The base member 64 and the covering member 65 may be bonded to each other with an adhesive. The base member 64 and the covering member 65 may be welded with irradiation with an ultraviolet ray, a laser beam, or the like.

The maintenance unit 22 may be located inside the opening 35. The maintenance unit 22 may be smaller in sizes in the second direction D2 and the third direction D3 than the opening 35. The maintenance unit 22 and the positioning unit 23 are separable. The maintenance unit 22 can be replaced from the opening 35 by detaching the connector 37.

As illustrated in FIG. 4, the head unit 16 may include a first positioning portion 67 and an operation portion 68. The first positioning portion 67 and the operation portion 68 may each have a cylindrical shape. The head unit 16 may include a plurality of first positioning portions 67. The plurality of first positioning portions 67 may be disposed at intervals in the third direction D3.

As illustrated in FIG. 2, the maintenance unit 22 may include second positioning portions 70. The maintenance unit 22 may include a plurality of second positioning portions 70. The plurality of first positioning portions 67 can come into contact with the plurality of second positioning portions 70, respectively. The plurality of second positioning portions 70 may be disposed at intervals in the third direction D3. The plurality of second positioning portions 70 may be provided to the support portion 45. The plurality of second positioning portions 70 may have respective shapes different from each other.

The maintenance unit 22 in the present embodiment includes two second positioning portions 70. One of the second positioning portions 70 may have a flat surface perpendicular to the second direction D2. Therefore, one of the second positioning portions 70 positions the maintenance unit 22 and the head unit 16 in the second direction D2 by coming into contact with the first positioning portion 67.

The other of the second positioning portions 70 may have a first flat surface 70f and a second flat surface 70s. The first flat surface 70f and the second flat surface 70s are surfaces nonparallel to each other and face each other in the third direction D3. In the third direction D3, the narrowest distance between the first flat surface 70f and the second flat surface 70s is smaller than a dimension of the largest portion of the first positioning portion 67. Therefore, the other of the second positioning portions 70 positions the maintenance unit 22 and the head unit 16 in the second direction D2 and the third direction D3 by coming into contact with the first positioning portion 67.

### Positioning Unit

As shown in FIG. 4, the positioning unit 23 determines the position of the maintenance unit 22 with respect to the head unit 16. The positioning unit 23 may be located in a region outside the region between the opening 35 and the maintenance unit 22.

The positioning unit 23 may include a cam 72, a camshaft 73, a link 74, a lever 75, a biasing member 76, and a pressing member 77. The positioning unit 23 may include a plurality of cams 72 and a plurality of pressing members 77. The plurality of cams 72 may be disposed at intervals in the third direction D3. The plurality of pressing members 77 may be disposed at intervals in the third direction D3.

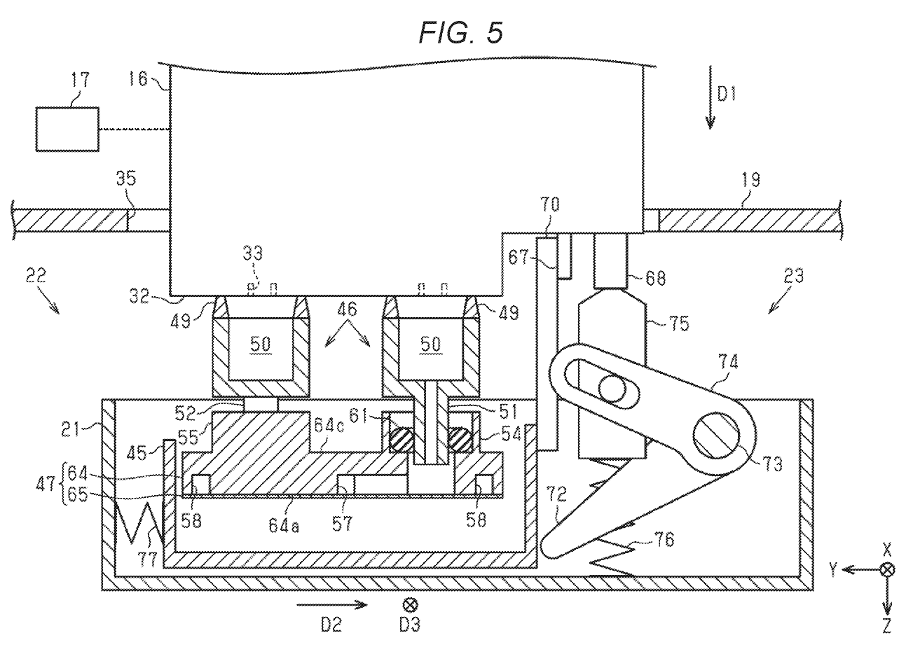

The cam 72 is provided to the camshaft 73 and rotates integrally with the camshaft 73. The cam 72 is displaceable between a first posture illustrated in FIG. 4 and a second posture illustrated in FIG. 5. The cam 72 in the first posture restricts the movement of the maintenance unit 22 toward the second direction D2. The cam 72 in the second posture allows the maintenance unit 22 to move toward the second direction D2.

The camshaft 73 may extend in the third direction D3.

The link 74 is provided to the camshaft 73 and rotates integrally with the camshaft 73. The link 74 can be disposed between the plurality of cams 72 in the third direction D3. The link 74 transmits a movement of the lever 75 to the camshaft 73.

The lever 75 is disposed so as to be able to reciprocate in the first direction D1. The biasing member 76 may push the lever 75 in an opposite direction to the first direction D1. The biasing member 76 may push up the lever 75. The biasing member 76 may push the lever 75 toward the head unit 16. The lever 75 displaces the cam 72. That is, when the lever 75 moves, the movement of the lever 75 is transmitted to the camshaft 73 by the link 74. The lever 75 rotates the cam 72 via the link 74 and the camshaft 73.

The pressing member 77 is, for example, a spring. The pressing member 77 biases the maintenance unit 22 toward the second direction D2. The pressing member 77 may press the maintenance unit 22 against the cam 72 in the first posture.

### Functions of Present Embodiment

Functions of the present embodiment will be described.

As shown in FIGS. 4 and 5, the moving mechanism 17 moves the head unit 16 and the caps 46 relative to each other in the first direction D1. The moving mechanism 17 in the present embodiment brings the nozzle surface 32 and the caps 46 into contact with each other by moving the head unit 16 toward the first direction D1.

The operation portion 68 of the head unit 16 moving toward the first direction D1 pushes the lever 75 toward the first direction D1. That is, the head unit 16 moving relative to the caps 46 operates the lever 75 to displace the cam 72 to the second posture. Then, the maintenance unit 22 and the second positioning portions 70 are pushed by the pressing member 77 to move toward the second direction D2. The pressing member 77 presses the second positioning portions 70 against the first positioning portions 67. The maintenance unit 22 and the head unit 16 are positioned in the second direction D2 and the third direction D3 by the second positioning portions 70 that is moving toward the second direction D2 coming into contact with the first positioning portions 67.

The head unit 16 is positioned with respect to the maintenance unit 22, and then comes into contact with the caps 46.

When the suction pump 41 is driven in the capping state, the insides of the caps 46 are depressurized via the discharge flow path 40, the merging flow path 57, the inflow portions 54, and the outflow portions 51. The suction pump 41 discharges the liquid from the plurality of nozzles 33 by depressurizing the insides of the caps 46.

The liquid thus discharged is received in the caps 46 and flows into the receiving member 47 via the outflow portions 51.

The liquid flowing into the receiving member 47 is collected in the waste liquid container 43 via the merging flow path 57 and the discharge flow path 40.

When the open valve 39 is opened, air flows into the caps 46 via the open flow path 38, the air flow path 58, the delivery portions 55, and the intake portions 52. When the air flows in, it becomes easy to discharge the liquid in the caps 46 and the receiving member 47.

### Advantages of Present Embodiment

Advantages of the present embodiment will be described.

(1-1) The receiving member 47 has the plurality of inflow portions 54. The caps 46 are coupled respectively to the plurality of inflow portions 54. That is, the plurality of caps 46 is directly coupled to the receiving member 47. Therefore, the size can be reduced compared to, for example, when the caps 46 and the receiving member 47 are connected with tubes.

(1-2) Coupling of the discharge flow path 40 to the receiving member 47 can be released. The maintenance unit 22 is located inside the opening 35 provided to the opposed portion 19. Therefore, the maintenance unit 22 can be detached through the opening 35. Therefore, the plurality of caps 46 and the receiving member 47 can be easily replaced.

(1-3) Precise dimensions are required when, for example, making the outflow portion 51 and the inflow portion 54 directly adhere to with each other. In this regard, the gap between the outflow portion 51 and the inflow portion 54 is caulked with the first seal member 61. Therefore, it is possible to easily reduce the possibility that the liquid leaks from the coupling portion between the outflow portion 51 and the inflow portion 54.

(1-4) When, for example, the discharge portion 56 is disposed at the first surface 64a provided with the merging flow path 57, there is required a space for coupling the discharge flow path 40 in a direction perpendicular to the first surface 64a, and therefore, the apparatus grows in size. In this regard, the discharge portion 56 is disposed at the second surface 64b. Since the discharge flow path 40 to be coupled to the discharge portion 56 can be arranged side by side with the merging flow path 57, the apparatus can be reduced in size.

(1-5) The positioning unit 23 is located outside the region between the opening 35 and the maintenance unit 22. Therefore, it is possible to reduce the possibility that the positioning unit 23 hinders the movement of the maintenance unit 22 detached through the opening 35.

(1-6) The tray 21 houses the maintenance unit 22 and the positioning unit 23. Therefore, a large capacity can be ensured compared to when, for example, only the maintenance unit 22 is housed.

(1-7) The head unit 16 moving relative to the caps 46 displaces the cam 72 to the second posture. When the cam 72 is displaced to the second posture, the maintenance unit 22 is allowed to move toward the second direction D2. The maintenance unit 22 is biased toward the second direction D2 by the pressing member 77. Therefore, the maintenance unit 22 is positioned with respect to the head unit 16 by moving toward the second direction D2 to press the second positioning portions 70 against the first positioning portions 67. Therefore, it is possible to reduce the size compared to when the positioning of the head unit 16 and the maintenance unit 22 is performed using a motor.

(1-8) The first flat surface 70f and the second flat surface 70s provided to the second positioning portion 70 are nonparallel to each other and face each other in the third direction D3. Therefore, by positioning the first positioning portion 67 between the first flat surface 70f and the second flat surface 70s, the head unit 16 and the maintenance unit 22 can be positioned in the second direction D2 and the third direction D3.

(1-9) When, for example, the maintenance unit 22 is pressed against a single cam 72, there is a possibility that the posture of the maintenance unit 22 is inclined. In this regard, the positioning unit 23 is provided with the plurality of cams 72. Therefore, the posture of the maintenance unit 22 can be stabilized.

(1-10) When, for example, a single first positioning portion 67 and a single second positioning portion 70 are brought into contact with each other, there is a possibility that the posture of the maintenance unit 22 is inclined. In this regard, the plurality of first positioning portions 67 and the plurality of second positioning portions 70 are provided. Therefore, the posture of the maintenance unit 22 can be stabilized.

(1-11) The maintenance unit 22 and the positioning unit 23 are separable. The maintenance unit 22 is located inside the opening 35 provided to the opposed portion 19. Therefore, the maintenance unit 22 can be detached through the opening 35. The positioning unit 23 is located outside the region between the opening 35 and the maintenance unit 22. Therefore, it is possible to reduce the possibility that the positioning unit 23 hinders the movement of the maintenance unit 22 detached through the opening 35. Therefore, the maintenance unit 22 can easily be replaced.

### Modified Examples

The present embodiment can be implemented with the modifications described below. The present embodiment and the following modified examples can be implemented in combination with each other as long as no technical inconsistencies are involved.

The air flow path 58 may be provided separately from the receiving member 47. The receiving member 47 may adopt a configuration not provided with the plurality of delivery portions 55 and the air flow path 58.

At least a part of the maintenance unit 22 may be located outside the tray 21. At least a part of the positioning unit 23 may be located outside the tray 21.

At least a part of the positioning unit 23 may be located in the region between the opening 35 and the maintenance unit 22.

At least one of the merging flow path 57 and the air flow path 58 may pass through a surface different from the first surface 64a. The receiving member 47 may include a plurality of covering members 65. The plurality of covering members 65 may form at least one of the merging flow path 57 and the air flow path 58 by, for example, covering the grooves formed at the first surface 64a and the third surface 64c.

The liquid ejection apparatus 11 may adopt a configuration not including at least one of the first seal member 61 and the second seal member 62. The outflow portion 51 and the inflow portion 54 may be caused to adhere to each other by, for example, providing elasticity to at least one of the outflow portion 51 and the inflow portion 54. The intake portion 52 and the delivery portion 55 may be caused to adhere to each other by providing elasticity to at least one of the intake portion 52 and the delivery portion 55. The gap may be eliminated by, for example, matching the dimensions of the outflow portion 51 and the intake portion 52 with those of the inflow portion 54 and the delivery portion 55.

The size of the maintenance unit 22 may be larger than the opening 35.

The maintenance unit 22 may be provided separately from the opposed portion 19.

The maintenance unit 22 may be replaceable together with the positioning unit 23.

The opposed portion 19 that houses the maintenance unit 22 and the positioning unit 23 may be replaceable. That is, the maintenance unit 22, the positioning unit 23, and the opposed portion 19 may be collectively replaceable.

The head unit 16 may include a single first positioning portion 67. The maintenance unit 22 may include a single second positioning portion 70. The positioning unit 23 may include a single cam 72. In this case, it is preferable that the inclinations of the postures of the head unit 16 and the maintenance unit 22 are restricted by a posture holding portion (not illustrated).

One second positioning portion 70 may have the flat surface perpendicular to the second direction D2. One second positioning portion 70 may have the first flat surface 70f and the second flat surface 70s.

The plurality of second positioning portions 70 may each have a flat surface perpendicular to the second direction D2.

The first positioning portion 67 may have the first flat surface 70f and the second flat surface 70s. The second positioning portion 70 may have a cylindrical shape.

The moving mechanism 17 may move the maintenance unit 22. The moving mechanism 17 may move both the head unit 16 and the maintenance unit 22.

The liquid ejection apparatus 11 may be a liquid ejection apparatus that jets or ejects a liquid other than ink. The state of the liquid to be ejected from the liquid ejection apparatus as a minute amount of droplet includes a particle state, a teardrop state, and a state of tailing like a thread. The liquid mentioned here may sufficiently be any material that can be ejected from the liquid ejection apparatus. For example, the liquid may be any substance in a liquid phase and includes a liquid material high or low in viscosity, sol, gel water, other inorganic solvents, organic solvents, solutions, and a fluid material such as liquid resin, liquid metal, and metal melt. The liquid includes not only a liquid as one state of a substance, but also a liquid obtained by dissolving, dispersing, or mixing particles of a functional material formed of a solid substance such as pigments or metal particles in a solvent. Representative examples of the liquid include such ink as described in the above embodiment and a liquid crystal. Here, the term ink includes various types of liquid compositions such as general water-based ink, oil-based ink, gel ink, and hot melt ink. Specific examples of the liquid ejection apparatus include an apparatus that ejects a liquid containing, in a dispersed or dissolved form, a material such as an electrode material or a coloring material used for manufacturing, for example, a liquid crystal display, an electroluminescence display, a surface-emitting display, and a color filter. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of transparent resin such as ultraviolet curable resin onto a substrate in order to form a minute hemispherical lens used for an optical communication element or the like, an optical lens, or the like. The liquid ejection apparatus may be an apparatus that ejects an acid or alkali etching solution in order to etch a substrate or the like.

### Definitions

The expression "at least one" used in this specification means "one or more" of desired options. For example, the expression "at least one" used in the present specification means "either one of alternatives" or "both of two alternatives" when the number of the alternatives is two. As another example, the expression "at least one" used in the present specification means "just one alternative", "a combination of any two alternatives", or "a combination of any three or more alternatives" when the number of alternatives is three or more.

### Appendices

Technical ideas understood from the embodiment and modified examples described above and the functions and advantages thereof will hereinafter be described.

1 A liquid ejection apparatus includes a head unit having a nozzle surface provided with a plurality of nozzles configured to eject a liquid toward a medium, a plurality of caps configured to receive the liquid discharged from the head unit, a receiving member configured to receive the liquid discharged from the plurality of caps, and a discharge flow path configured to connect the receiving member and a waste liquid container to each other, wherein the plurality of caps each includes a lip portion configured to come into contact with the nozzle surface, and an outflow portion that is located at an opposite side to the head unit with respect to the lip portion to be in contact with the nozzle surface and is configured to cause the liquid received to flow out, and the receiving member includes a plurality of inflow portions coupled respectively to a plurality of outflow portions each identical to the outflow portion, a discharge portion to which the discharge flow path is coupled, and a merging flow path configured to connect the plurality of inflow portions and the discharge portion to each other.

According to this configuration, the receiving member includes the plurality of inflow portions. The caps are respectively coupled to the plurality of inflow portions. That is, the plurality of caps is directly connected to the receiving member. Therefore, the size can be reduced compared to, for example, when the caps and the receiving member are connected with tubes.

[2] The liquid ejection apparatus according to 1 described above may further include an opposed portion disposed so as to face the head unit, and a maintenance unit including the receiving member and the plurality of caps, wherein the opposed portion may include an opening, the discharge flow path may be detachably attached to the receiving member, and the maintenance unit may be located inside the opening.

According to this configuration, coupling of the discharge flow path to the receiving member can be released. The maintenance unit is located inside the opening provided to the opposed portion. Therefore, the maintenance unit can be detached through the opening. Therefore, the plurality of caps and the receiving member can easily be replaced.

[3] The liquid ejection apparatus according to [1] or [2] described above may further include a seal member with which a gap between the outflow portion and the inflow portion is caulked.

When, for example, the outflow portion and the inflow portion are made to directly adhere to each other, precise dimensions are required. In this regard, according to this configuration, the gap between the outflow portion and the inflow portion is caulked with the seal member. Therefore, it is possible to easily reduce the possibility that the liquid leaks from the coupling portion between the outflow portion and the inflow portion.

[4] In the liquid ejection apparatus according to any one of [1] to [3] described above, the receiving member may include a base member provided with a groove, and a covering member bonded to the base member to cover the groove to form, with the groove, the merging flow path, the base member may include a first surface at which the groove is formed, and a second surface crossing the first surface, and the discharge portion may be disposed at the second surface.

When, for example, the discharge portion is disposed at the first surface provided with the merging flow path, there is required a space for coupling the discharge flow path in a direction perpendicular to the first surface, and therefore, the apparatus grows in size. In this regard, according to this configuration, the discharge portion is disposed at the second surface. Since the discharge flow path to be coupled to the discharge portion can be arranged side by side with the merging flow path, the apparatus can be reduced in size.

[5] The liquid ejection apparatus according to [2] described above may further include a positioning unit configured to determine a position of the maintenance unit with respect to the head unit, wherein the positioning unit may be located in a region outside a region between the opening and the maintenance unit.

According to this configuration, the positioning unit is located outside the region between the opening and the maintenance unit. Therefore, it is possible to reduce the possibility that the positioning unit hinders the movement of the maintenance unit detached through the opening.

[6] The liquid ejection apparatus according to [5] described above may further include a tray configured to receive the liquid leaked, wherein the maintenance unit and the positioning unit may be disposed in the tray.

According to this configuration, the tray houses the maintenance unit and the positioning unit. Therefore, it is possible to ensure a large capacity compared to when, for example, only the maintenance unit is housed.

[7] A liquid ejection apparatus includes a head unit having a nozzle surface provided with a plurality of nozzles configured to eject a liquid toward a medium, a maintenance unit including a cap configured to receive the liquid ejected from the head unit, a positioning unit configured to determine a position of the maintenance unit with respect to the head unit, and a moving mechanism configured to move the head unit and the cap relative to each other in a first direction to bring the nozzle surface and the cap into contact with each other, wherein the head unit includes a first positioning portion, the maintenance unit includes a second positioning portion configured to come into contact with the first positioning portion, the positioning unit includes a cam configured to be displaced between a first posture of restricting a movement of the maintenance unit toward a second direction and a second posture of allowing the movement of the maintenance unit toward the second direction, a lever configured to displace the cam, and a pressing member configured to bias the maintenance unit toward the second direction and press the maintenance unit against the cam in the first posture, and when the head unit configured to move relative to the cap operates the lever to displace the cam to the second posture, the pressing member presses the second positioning portion against the first positioning portion.

According to this configuration, the head unit that moves relative to the cap displaces the cam to the second posture. When the cam is displaced to the second posture, the maintenance unit is allowed to move toward the second direction. The maintenance unit is biased toward the second direction by the pressing member. Therefore, the maintenance unit is positioned with respect to the head unit by moving toward the second direction to press the second positioning portion against the first positioning portion. Therefore, it is possible to reduce the size compared to when the positioning of the head unit and the maintenance unit is performed using a motor.

[8] In the liquid ejection apparatus according to [7]described above, one of the first positioning portion and the second positioning portion may have a first flat surface and a second flat surface nonparallel to the first flat surface, and the first flat surface and the second flat surface may face each other in a third direction.

According to this configuration, the first flat surface and the second flat surface provided to one of the first positioning portion and the second positioning portion are nonparallel to each other and face each other in the third direction. Therefore, by positioning the other of the first positioning portion and the second positioning portion between the first flat surface and the second flat surface, the head unit and the maintenance unit can be positioned in the second direction and the third direction.

[9] In the liquid ejection apparatus according to [8] described above, the positioning unit may include a plurality of cams each identical to the cam and disposed at intervals in the third direction.

When, for example, the maintenance unit is pressed against a single cam, there is a possibility that the posture of the maintenance unit is inclined. In this regard, according to this configuration, the positioning unit includes the plurality of cams. Therefore, the posture of the maintenance unit can be stabilized.

[10] In the liquid ejection apparatus according to any one of [7] to [9] described above, the head unit may include a plurality of first positioning portions each identical to the first positioning portion, the maintenance unit may include a plurality of second positioning portions each identical to the second positioning portion, and the plurality of first positioning portions may be configured to come into contact with the plurality of second positioning portions, respectively.

According to this configuration, when, for example, a single first positioning portion and a single second positioning portion are brought into contact with each other, there is a possibility that the posture of the maintenance unit is inclined. In this regard, according to this configuration, the plurality of first positioning portions and the plurality of second positioning portions are provided. Therefore, the posture of the maintenance unit can be stabilized.

[11] The liquid ejection apparatus according to any one of [7] to [10] described above may further include an opposed portion disposed so as to face the head unit, wherein the opposed portion may be provided with an opening, the maintenance unit and the positioning unit may be separable, the maintenance unit may be located inside the opening, and the positioning unit may be located in a region outside a region between the opening and the maintenance unit.

According to this configuration, the maintenance unit and the positioning unit are separable. The maintenance unit is located inside the opening provided to the opposed portion. Therefore, the maintenance unit can be detached through the opening. The positioning unit is located outside the region between the opening and the maintenance unit. Therefore, it is possible to reduce the possibility that the positioning unit hinders the movement of the maintenance unit detached through the opening. Therefore, the maintenance unit can easily be replaced.

[12] The liquid ejection apparatus according to any one of [7] to [11] described above may further include a tray configured to receive the liquid leaked, wherein the maintenance unit and the positioning unit may be disposed in the tray.

According to this configuration, it is possible to achieve substantially the same advantages as those of the liquid ejection apparatus described above.

What is claimed is:

1. A liquid ejection apparatus comprising:
a head unit having a nozzle surface provided with a plurality of nozzles configured to eject a liquid toward a medium;
a plurality of caps configured to receive the liquid discharged from the head unit;
a receiving member configured to receive the liquid discharged from the plurality of caps; and
a discharge flow path configured to connect the receiving member and a waste liquid container to each other, wherein
the plurality of caps each includes
a lip portion configured to come into contact with the nozzle surface, and
an outflow portion that is located at an opposite side to the head unit with respect to the lip portion to be in contact with the nozzle surface and is configured to cause the liquid received to flow out, and
the receiving member includes
a plurality of inflow portions coupled respectively to a plurality of outflow portions each identical to the outflow portion,
a discharge portion to which the discharge flow path is coupled, and
a merging flow path configured to connect the plurality of inflow portions and the discharge portion to each other.

2. The liquid ejection apparatus according to claim 1, further comprising:
an opposed portion disposed so as to face the head unit; and
a maintenance unit including the receiving member and the plurality of caps, wherein
the opposed portion includes an opening,
the discharge flow path is detachably attached to the receiving member, and
the maintenance unit is located inside the opening.

3. The liquid ejection apparatus according to claim 1, further comprising
a seal member with which a gap between the outflow portion and the inflow portion is caulked.

4. The liquid ejection apparatus according to claim 1, wherein
the receiving member includes
a base member provided with a groove, and
a covering member bonded to the base member to cover the groove to form, with the groove, the merging flow path,
the base member includes
a first surface at which the groove is formed, and
a second surface crossing the first surface, and
the discharge portion is disposed at the second surface.

5. The liquid ejection apparatus according to claim 2, further comprising
a positioning unit configured to determine a position of the maintenance unit with respect to the head unit, wherein
the positioning unit is located in a region outside a region between the opening and the maintenance unit.

6. The liquid ejection apparatus according to claim 5, further comprising
a tray configured to receive the liquid leaked, wherein
the maintenance unit and the positioning unit are disposed in the tray.

7. A liquid ejection apparatus comprising:
a head unit having a nozzle surface provided with a plurality of nozzles configured to eject a liquid toward a medium;
a maintenance unit including a cap configured to receive the liquid ejected from the head unit;
a positioning unit configured to determine a position of the maintenance unit with respect to the head unit; and
a moving mechanism configured to move the head unit and the cap relative to each other in a first direction to bring the nozzle surface and the cap into contact with each other, wherein
the head unit includes a first positioning portion,
the maintenance unit includes a second positioning portion configured to come into contact with the first positioning portion,
the positioning unit includes
a cam configured to be displaced between a first posture of restricting a movement of the maintenance unit toward a second direction and a second posture of allowing the movement of the maintenance unit toward the second direction,
a lever configured to displace the cam, and
a pressing member configured to bias the maintenance unit toward the second direction and press the maintenance unit against the cam in the first posture, and
when the head unit configured to move relative to the cap operates the lever to displace the cam to the second posture, the pressing member presses the second positioning portion against the first positioning portion.

8. The liquid ejection apparatus according to claim 7, wherein
one of the first positioning portion and the second positioning portion has a first flat surface and a second flat surface nonparallel to the first flat surface, and
the first flat surface and the second flat surface face each other in a third direction.

9. The liquid ejection apparatus according to claim 8, wherein
the positioning unit includes a plurality of cams each identical to the cam and disposed at intervals in the third direction.

10. The liquid ejection apparatus according to claim 7, wherein
the head unit includes a plurality of first positioning portions each identical to the first positioning portion,
the maintenance unit includes a plurality of second positioning portions each identical to the second positioning portion, and
the plurality of first positioning portions is configured to come into contact with the plurality of second positioning portions, respectively.

11. The liquid ejection apparatus according to claim 7, further comprising
an opposed portion disposed so as to face the head unit, wherein
the opposed portion is provided with an opening,
the maintenance unit and the positioning unit are separable,
the maintenance unit is located inside the opening, and
the positioning unit is located in a region outside a region between the opening and the maintenance unit.

12. The liquid ejection apparatus according to claim 7, further comprising
a tray configured to receive the liquid leaked, wherein
the maintenance unit and the positioning unit are disposed in the tray.
